(19) United States
(12) Patent Application Publication
(10) Pub. No.: US 2015/0118631 A1
(43) Pub. Date: Apr. 30, 2015

(54) METHOD AND DEVICE FOR CONTROLLING EXCESS AIR IN A FURNACE

(71) Applicant: Carrier Corporation, Farmington, CT (US)

(72) Inventors: Wiliam J. Roy, Avon, IN (US); Kevin D. Thompson, Indianapolis, IN (US); Eric E. Tournier, Zionsville, IN (US)

(73) Assignee: Carrier Corporation

(21) Appl. No.: 14/514,475

(22) Filed: Oct. 15, 2014

Related U.S. Application Data
(60) Provisional application No. 61/897,388, filed on Oct. 30, 2013.

(51) Int. Cl. F27D 19/00

(52) U.S. Cl. CPC F27D 19/00; F27D 2019/0028
USPC 432/29; 432/36

(57) ABSTRACT

A device and method of controlling excess air during and after ignition of a gas furnace by operating a variable speed combustion blower assembly at an initial speed; operating a gas valve assembly and a burner assembly to initiate an ignition sequence; operating the variable speed combustion blower assembly at an increasing plurality of speeds until an excess air measurement is less than or equal to a predetermined value, and operating the variable speed combustion blower assembly at a steady state airflow rate to maintain the excess air measurement at the predetermined value.

### CROSS REFERENCE TO RELATED APPLICATIONS

The present application is related to, and claims the priority benefit of, U.S. Provisional Patent Application Ser. No. 61/897,338 filed Oct. 30, 2013, the contents of which are hereby incorporated in their entirety into the present disclosure.

### TECHNICAL FIELD OF THE DISCLOSED EMBODIMENTS

The presently disclosed embodiments generally relate to appliances for heating air, and more particularly, to a device and method for controlling excess air in a furnace.

### BACKGROUND OF THE DISCLOSED EMBODIMENTS

The operation of an induced-draft gas furnace can be optimized by maintaining the proper ratio of the gas input rate and the combustion airflow rate. Generally, the ideal ratio is offset for safety precautions by providing slightly more combustion air (i.e. excess air) than that required for optimum combustion efficiency conditions. In order for furnace heat losses to be minimized, it is important that the excess air level is controlled.

Excess air is proportional to the pressure drop across a heat exchanger, and is generally maintained at a predetermined constant level for a given gas input rate. Generally, one means of controlling the excess air level is to use a negative regulation gas valve to control the excess air level. Negative pressure created by a combustion blower pulls gas from the gas valve. As the combustion blower speeds and slows, pulling more or less gas from the valve. With this configuration, the air-to-gas ratio remains relatively constant across a wide band of input. However, implementation of a negative regulation gas control generally increases the pressure drop of the system; thus, requiring a larger sized combustion blower and adding cost to the furnace. There is, therefore, a need to control excess air without a large pressure drop and increasing the size of the combustion blower.

### SUMMARY OF THE DISCLOSED EMBODIMENTS

In one aspect, a method for controlling excess air during and after ignition of a furnace is provided. In one embodiment, the method includes the steps of operating a variable speed combustion blower assembly at an initial airflow rate. In one embodiment, the initial airflow rate includes a predetermined airflow rate. In one embodiment, the predetermined airflow rate is less than or equal to approximately 10 cubic feet per hour (CFH) per British Thermal Unit (BTU). In another embodiment, the initial airflow rate comprises a variable airflow rate.

The method includes the step of operating the gas valve assembly and the burner assembly to initiate an ignition sequence. The method also includes the step of operating the variable speed combustion blower assembly at an increasing plurality of speeds until an excess air measurement is less than or equal to a predetermined value. In one embodiment, the plurality of speeds are such to maintain the initial airflow rate. In one embodiment, the predetermined value of excess air is less than or equal to approximately 40% excess air. The method includes the step of operating the variable speed combustion blower assembly at a steady state airflow rate to maintain the excess air measurement at the predetermined value.

### BRIEF DESCRIPTION OF THE DRAWINGS

The embodiments and other features, advantages and disclosures contained herein, and the manner of attaining them, will become apparent and the present disclosure will be better understood by reference to the following description of various exemplary embodiments of the present disclosure taken in conjunction with the accompanying drawings, wherein:

FIG. 1 is a component diagram of a gas furnace according to the present disclosure; and

FIG. 2 is a schematic flow diagram of a method for controlling excess air during and after ignition of a furnace.

### DETAILED DESCRIPTION OF THE DISCLOSED EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

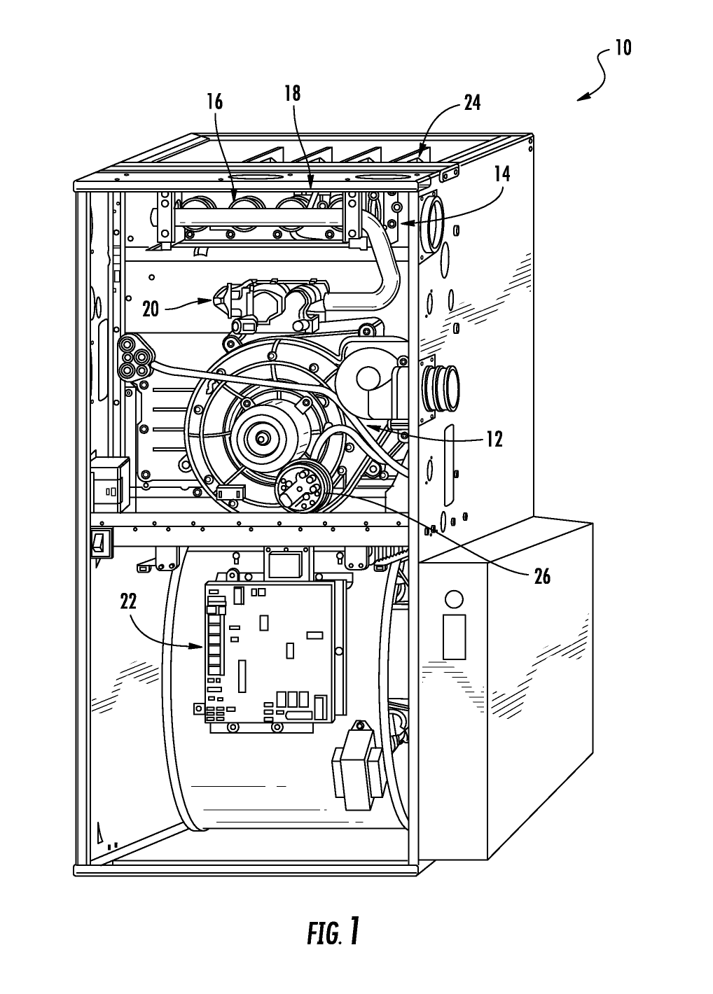

FIG. 1 illustrates a gas fired furnace, generally referenced at 10. The furnace 10 includes a variable speed combustion blower assembly 12, a burner assembly 14 including at least one burner 16 and an igniter 18, a gas valve assembly 20, and at least one air proving switch 26. The gas furnace 10 also includes a controller 22 operably coupled to the combustion blower assembly 12, the burner assembly 14, and the gas valve assembly 20 for the control thereof. The controller 22 is operably coupled to the at least one air proving switch 26 to receive at least one signal therefrom.

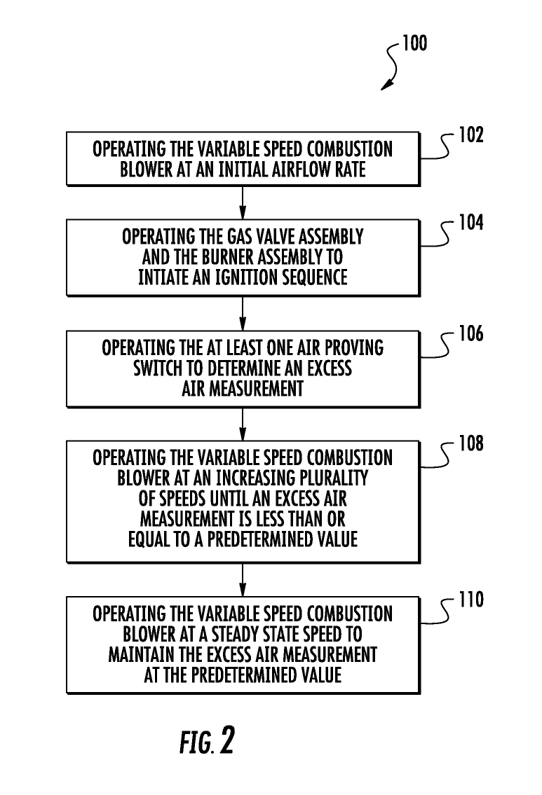

FIG. 2 illustrates a schematic flow diagram of an exemplary method 100 for controlling excess air during and after ignition of a furnace. The method includes the step 102 of operating the variable speed combustion blower assembly 12 at an initial airflow rate. For example, the controller 22 may receive a start instruction from a thermostat (not shown), to name one non-limiting example. After receiving the start instruction, the controller 22 sends power to the variable speed combustion blower assembly 12 to begin rotation of a combustion blower fan therein to induce an airflow through the burner assembly 14. In one embodiment, the initial airflow rate of the variable speed combustion blower assembly 12 includes a predetermined airflow rate. For example, the predetermined airflow rate may be representative of a pre-ignition airflow rate that is consistent with an excess air level at ignition. In one embodiment, the predetermined airflow rate is less than or equal to approximately 10 cubic feet per hour (CFH) per British Thermal Unit (BTU). In another embodiment, the initial airflow rate comprises a variable airflow rate. For example, as the variable speed combustion blower assembly 12 rotates, an airflow in a heat exchanger system 24 occurs. If there are no obstructions in a flue pipe (not shown) operably coupled to the furnace 10, the variable speed combustion blower assembly 12 will create a pressure to the at least one air proving switch 26. The variable speed combustion blower assembly 12 increases airflow rate until there is a sufficient draft in the heat exchanger system 24. When there is a sufficient draft, contacts within the at least one air proving switch 26 will close. Once the contacts within the at least one air proving switch 26 close, the at least one air proving switch 26 sends a signal to the controller 22, at which point the controller 22 determines the current airflow rate of the variable speed combustion blower assembly 12 and sets the current airflow rate as the initial airflow rate.

In one embodiment, the method 100 includes step 104 of operating the gas valve assembly 20 and the burner assembly 14 to initiate an ignition sequence. Generally, the gas valve assembly 20 controls a flow of fuel, such as natural gas to name one non-limiting example, from a fuel source (not shown) to the burner assembly 14. The gas valve may be controlled by a solenoid (not shown), to name one non-limiting example, that actuates to open the gas valve assembly 20 when power is provided by the controller 22. The burner assembly 14 receives a flow of air from the variable speed combustion blower assembly 12. The air pulled in from the variable speed combustion blower assembly 12 mixes with the fuel and is ignited by the igniter 18 within the burner assembly 14.

In one embodiment, the method 100 includes step 106 of operating the at least one air proving switch 26 to determine an excess air measurement. For example, the excess air measurement is obtained by measuring the pressure drop across the heat exchanger system using the at least one air proving switch 26, as the pressure drop across the heat exchanger system 24 is indicative of the level of excess air in the burner assembly 14. As is known in the art, the at least one air proving switch 26 is calibrated to make (or close) at specific pressure differentials, so it can be used to measure the pressure drop across the heat exchanger system 24, as an indication of the level of excess air in the burner assembly 14.

In one embodiment, the method 100 includes step 108 of operating the variable speed combustion blower assembly 12 at a plurality of increasing speeds until the excess air measurement is less than or equal to a predetermined value. After ignition, the controller 22 commands the variable speed combustion blower assembly 12 to increase the rotational speed of the variable speed combustion blower fan to maintain the initial airflow rate. In one embodiment, the predetermined value of excess air is less than or equal to approximately 40% excess air.

In one embodiment, the method 100 includes step 110 of operating the variable speed combustion blower assembly 12 at a steady state airflow rate to maintain the excess air measurement at the predetermined value. After the predetermine value of excess air has been achieved, the controller 22 commands the variable speed combustion blower assembly 12 to maintain the airflow rate of the variable speed combustion blower fan until the end of the heating cycle.

It will be appreciated that the variable speed combustion blower assembly 12 and the burner assembly 14 work independently to control the amount of excess air and air-gas mixture during and after the ignition of the furnace 10.

While the invention has been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

What is claimed is:

1. A method of controlling excess air in a gas furnace including a variable speed combustion blower assembly, a controller, a burner assembly, at least one air proving switch, and a gas valve assembly, the method comprising the steps of:
(a) operating the variable speed combustion blower assembly at an initial airflow rate;
(b) operating the gas valve assembly and the burner assembly to initiate an ignition sequence;
(c) operating the at least one air proving switch to determine an excess air measurement;
(d) operating the variable speed combustion blower assembly at a plurality of increasing speeds until the excess air measurement is less than or equal to a predetermined value; and
(e) operating the variable speed combustion blower assembly at a steady state airflow rate to maintain the excess air measurement at the predetermined value.

2. The method of claim 1, wherein the initial airflow rate comprises a predetermined airflow rate.

3. The method of claim 2, wherein the predetermined speed is less than or equal to approximately 10 cubic feet per hour per British Thermal Unit.

4. The method of claim 1, wherein the initial airflow rate comprises a variable airflow rate.

5. The method of claim 1, wherein the plurality of increasing speeds are such to maintain the initial airflow rate.

6. The method of claim 1, wherein the predetermined value is less than or equal to approximately 40% excess air.

7. A gas furnace comprising:
variable speed combustion blower assembly;
a controller;
a burner assembly;
at least one air proving switch; and
a gas valve assembly
wherein the controller is configured to:
(a) operate the variable speed combustion blower assembly at an initial airflow rate;
(b) operate the gas valve assembly and the burner assembly to initiate an ignition sequence;
(c) operate the at least one air proving switch to determine an excess air measurement;
(d) operate the variable speed combustion blower assembly at a plurality of increasing speeds until the excess air measurement is less than or equal to a predetermined value; and
(e) operate the variable speed combustion blower assembly at a steady state airflow rate to maintain the excess air measurement at the predetermined valve.

8. The gas furnace of claim 7, wherein the initial airflow rate comprises a predetermined airflow rate.

9. The gas furnace of claim 8, wherein the predetermined speed is less than or equal to approximately 10 cubic feet per hour per British Thermal Unit.

10. The gas furnace of claim 7, wherein the initial airflow rate comprises a variable airflow rate.

11. The gas furnace of claim 7, wherein the plurality of increasing speeds maintain the initial airflow rate.

12. The gas furnace of claim 7, wherein the predetermined value is less than or equal to approximately 40% excess air.
